(19) United States
(12) Patent Application Publication
(10) Pub. No.: US 2026/0301303 A1
(43) Pub. Date: Oct. 1, 2026

(54) VIDEO DIFFUSION MODELS WITH TEMPORALLY CONSISTENT NOISE

(71) Applicant: NVIDIA Corp., Santa Clara, CA (US)

(72) Inventors: Chao Liu, Santa Clara, CA (US); Arash Vahdat, San Mateo, CA (US)

(73) Assignee: NVIDIA Corp., Santa Clara, CA (US)

(21) Appl. No.: 19/575,327

(22) Filed: Mar. 23, 2026

Related U.S. Application Data
(60) Provisional application No. 63/776,489, filed on Mar. 24, 2025.

(51) Int. Cl. G06T 15/04; G06T 15/20; G06T 17/20

(52) U.S. Cl. CPC G06T 15/04; G06T 15/20; G06T 17/20

(57) ABSTRACT

Two and three dimensional video diffusion models configured via training to be equivariant to spatial transformations of the input by training the model using warped noise, where equivariance of the models is learned using a conventional video diffusion loss function modified to replace independent noise inputs with warped noise inputs.

### CROSS-REFERENCE TO RELATED APPLICATIONS

This application claims priority and benefit under 35 U.S.C. 119(e) to U.S. Application Ser. No. 63/776,489, “EquiVDM: Video Diffusion Models with Temporally Consistent Noise”, filed on Mar. 24, 2025, the contents of which are incorporated herein by reference in their entirety.

### BACKGROUND

Recent advancements in image generation have significantly improved the quality of generated images, enabling the generation of photorealistic visuals using advanced diffusion models. Video generation is an extension of image generation that introduces an additional layer of complexity due to the need for temporal consistency between video frames. Accurate video generation often requires high-quality frame-by-frame generation and the ability to model coherent and consistent temporal dynamics that depict natural motions.

Conventional approaches to achieving temporal consistency in generated videos include incorporation of three dimensional (3D) convolutions into diffusion-based models to improve the capture and propagation of spatiotemporal features. This approach typically involves extensive training of the model on large-scale, high-quality video datasets.

An alternative approach attempts to generate temporally consistent frames by directly sampling from temporally correlated noise. This is particularly appealing for video-to-video applications where an input video (“driving video”) may be used to “drive” the coherent noise.

Conventional diffusion networks are not intrinsically equivariant to noise warping transformations due to their highly nonlinear layers. Consequently conventional approaches that utilize warped noise require sampling-time guidance or regularization mechanisms to achieve approximate equivariance in the model. This involves the application of additional hyperparameters and complexity into the video generation process. Generating videos with coherent motion and temporally consistent content therefor remains a challenging problem.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts aspects of a diffusion model in accordance with one embodiment.

FIG. 2 depicts aspects of a 3D denoising model in accordance with one embodiment.

FIG. 3 depicts an embodiment of a denoising U-Net network.

FIG. 4 depicts a parallel processing unit in accordance with one embodiment.

FIG. 5 depicts a general processing cluster in accordance with one embodiment.

FIG. 6 depicts a memory partition unit in accordance with one embodiment.

FIG. 7 depicts a streaming multiprocessor in accordance with one embodiment.

FIG. 8 depicts a processing system in accordance with one embodiment.

FIG. 9 depicts an exemplary processing system in accordance with another embodiment.

### DETAILED DESCRIPTION

Disclosed herein are video generation system embodiments utilizing diffusion models and temporally consistent noise to generate temporally-coherent video frames, obviating the use of specialized modules and additional constraints.

The disclosed models apply a training objective with a temporally consistent noise source to urge the model configuration toward equivariance to spatial transformations of its inputs. The injected noise for each frame comprises a warped version of the noise applied to other frames (e.g., temporally-preceding frames). The noise warping function defines the motion of the video. For example, to generate a video with the camera panning to the left, in which the frames shift to the right, the noise inputs may comprise shifting noise with the shift direction oriented towards the right. This differs from conventional video diffusion models where the noise frames are random, without any correlation between frames. The warping function between frames may derive from either a driving video (e.g. low quality) or from a two-dimensional (2D) rendering of noise attached to 3D meshes.

Models configured (trained) in this manner may achieve superior alignment with motion patterns across frames, resulting in the production of smooth motion and high fidelity frames. Such diffusion models may generate temporally coherent video sequences with many fewer sampling steps than conventional diffusion models, and may substantially reduce execution time and utilization of computational resources without commensurate loss of output quality.

Models configured in this manner may outperform existing video-to-video diffusion models that require additional structure to encode per-frame dense conditions. The disclosed mechanisms may be extended to 3D video generation by attaching noise as textures on 3D meshes and may achieve superior motion alignment, 3D consistency, and video quality over conventional approaches.

The video diffusion models may be configured via training to be equivariant to spatial transformations of the input by training the model using warped noise. The models may also be trained to be equivariant to spatial warping transformations of the input noise. The need for additional regularization or modifications to the model structure may be obviated. The equivariance of the models may be learned using a conventional video diffusion loss function modified to replace independent noise inputs with warped noise inputs. Unlike conventional approaches, equivariance is configured as an inherent property of the diffusion model via training.

Temporal coherence may be achieved in the generated videos without additional model structure or execution overhead. Temporally-consistent noise sources may for example be derived from motion vectors in videos in manners known in the art. To construct 3D-consistent noise, the disclosed mechanisms may attach Gaussian noise as textures to 3D meshes and render the resulting noised frames from various camera viewpoints. These renderings may then be applied as the noise training inputs to the diffusion model.

Diffusion models may be trained on two-dimensional (2D) videos without 3D information using motion-based warped noise. For inference, 3D-consistent noise may be applied.

The equivariance of the disclosed diffusion models aligns generated video frames in accordance with the 3D geometry and camera poses inherent in the inputs. The disclosed mechanisms may therefor have utility in applications for which a 3D mesh of the input scene is available (e.g., video games, simulations).

The following terms may be utilized herein:

| Term | Meaning |
|---|---|
| V | Generated video |
| V^{(k)} | Video frame k of video V |
| K | Total number of video frames in generated video V |
| D_{θ} | Video diffusion model |
| Vₜ | Noised video |
| ${V}_{t}^{( k )}$ | Noised video frame k |
| ε^{(k)} | Gaussian noise in noised video frame Vₜ^{(k)} |
| I(p) | source image |
| τ | warping operator |
| τₖ | warping operator applied to video frame k |
| τ○ε(p) | warped noise value |
| [symbol] ₚ(V, Vₜ)[V^{(k)}] | Expected value of V₍ₖ₎ from applying operator τₖ |
| Ωₚ | the set of pixels in the source noise covered by a deformed pixel after |
| | warping |
| \|Ωₚ\| | the number of pixels in the area covered by a deformed pixel after warping |
| ϵᵤₚ(Aᵢ) | the stochastically upsampled noise value of deformed pixel i |
| Aᵢ | pixel after warping function applied |
| ϵᵤᵥ | Gaussian noise texture map |
| τ_{k,uv} | warping transformation from a UV texture map to the image plane for camera |
| | view k |
| τ_{k,j} | the effective warping operation from the j^{th} image to the k^{th} image |
| ${τ}_{k , uv} ∘ {τ}_{j , uv}^{- 1}$ | |
| β ∈ [0, 1] | hyperparameter controlling the strength of temporally-consistent noise |
| ϵ_{ind} | independent noise |
| ϵ_{warp} | warped noise |
| [symbol] | per-frame denoising loss |
| c | denoising model inputs |
| ${D}_{θ}^{( k )} ( {V}_{t} )$ | k^{th} frame of denoised video |

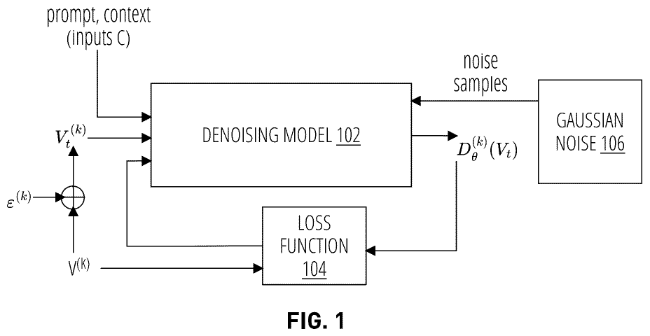

Referring to FIG. 1, a denoising model 102 (D_{θ}) may be configured via training to transform inputs c (text prompts, control frames, 3D meshes, etc.) into a video V=(V⁽⁰⁾, V⁽¹⁾, . . . V^{(K)}). The model D_{θ} predicts clean video frame

$${D}_{θ}^{( k )} ( {V}_{t} )$$

of the output video V from corresponding noised video frames

$${V}_{t}^{( k )} = {V}^{( k )} + {ε}^{( k )} .$$

Configuration of the model D_{θ} during training may be achieved by minimizing a per-frame denoising loss function 104. The denoising model 102 is trained to be equivariant by maintaining consistent (but progressively/cumulatively warped) input noise ε^{(k)} across a temporal ordering of frames and utilizing a loss function 104

$$ℒ = {𝔼}_{p ( V , {V}_{t} )} {\sum }_{k} {\vert {D}_{θ}^{( k )} ( {V}_{t} ) - {V}^{( k )} \vert}_{2}^{2} . \qquad ( Equation 1 )$$

In other words, the loss function may comprise conventional diffusion model L2 norm loss.

The trained model may generate video by iteratively denoising a randomly sampled Gaussian noise 106 following a sampling schedule. Various suitable sampling schedules are known in the art.

Due to the temporal consistency of video frames, the transformation of regions visible in pairs of frames in the video may be modeled by a warping operation τ∘I(p)=I(τ⁻¹(p)).

The warping operator r may be derived from a driving video or derived from a three-dimensional (3D) mesh and camera trajectory. T∘I(p) represents the warped image.

The warped image may be generated via interpolation of natural (e.g., camera) images. However, interpolation-based warping may break down the Gaussian distribution of noise in the fames and cause the input noise to be spatially correlated. To mitigate this effect, a noise transport operation may be utilized to warp the noise while maintaining its Gaussian distribution within each frame. The warped noise value may be determined by τ∘

$$ε ( p ) = \frac{1}{\sqrt{\vert {Ω}_{p} \vert}} {\sum }_{{A}_{i} ∈ {Ω}_{p}} {ε}_{up} ( {A}_{i} ) . \qquad ( Equation 2 )$$

A video V comprising K frames may be represented by the set of frames (V⁽⁰⁾, V⁽¹⁾, . . . V^{(K)}). The set N of noise distributions added to each frame k may be represented by (ε⁽⁰⁾, ε⁽¹⁾, . . . ε^{(K)}). A consistent cross-frame warping operation, e.g., τₖ∘V⁽⁰⁾, may be applied to each frame in the video V. A consistent warping operation (e.g., τₖ∘ε⁽⁰⁾) may also be applied to the noise introduced into each frame. The denoising model 102 D_{θ} trained to minimize the denoising loss [symbol] of Equation 1 may thereby become equivariant with respect to the transformation τₖ such that

$${D}_{θ}^{( k )} ( {V}_{t} ) = {τ}_{k} ∘ {D}_{θ}^{( 0 )} ( {V}_{t} ) .$$

Utilizing conventional denoising loss with warped noise trains the denoising model 102 D_{θ} to generate temporally consistent video frames that follow the motion patterns of the input noise. The model may be trained using the denoising loss in Equation 1 with noise from the first video frame V⁽⁰⁾ warped using motion vectors obtained from a driving video.

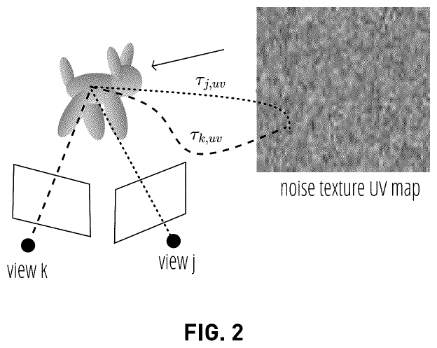

Referring to FIG. 2, the denoising model 102 may be configured to generate 3D video. A Gaussian noise texture (noise texture UV map) may be attached to an input 3D mesh surface. A Gaussian noise image is rendered from the 3D mesh, camera pose, and camera intrinsic characteristics. A warping transformation from the UV texture map to the image planes may be determined from the rasterization process. The noise transport operation (Equation 2) may then warp the Gaussian noise from the texture map to the image planes to obtain the noise set N for the video frames: N=(τ_{0,uv}∘εᵤᵥ, τ_{1,uv}∘εᵤᵥ, . . . , τ_{k,uv}∘εᵤᵥ).

3D-consistent video frames may be generated from 3D-consistent noise maps. The UV-to-image warping transformation is bijective and invertible. The corresponding image-to-UV warping operation is therefore

$${τ}_{k , uv}^{- 1} .$$

The 3D-consistent noise maps for a pair of physically proximate camera views are related by

$${ε}^{( k )} = {τ}_{k , uv} ∘ {ε}_{uv} = {τ}_{k , uv} ∘ {τ}_{j , uv}^{- 1} ∘ {ε}^{( j )} = {τ}_{k , j} ∘ {ε}^{( j )} .$$

The term τ_{k,j} thus represents the effective warping operation from the j^{th} frame to the k^{th} frame, i.e.,

$${V}^{( k )} = {τ}_{k , j} ∘ {V}^{( j )} .$$

For proximate camera views most regions in any one of the views may be visible in each other view. This condition holds for video sequences comprising a frames-per-second rate that is substantially higher (e.g., 2× or more higher) than the rate of camera position change. The pattern of τ_{k,uv} may differ from the frame-to-frame warping patterns in the training videos. However the 3D consistency of the generated video may be preserved without fine-tuning when τ_{k,uv} is similar to those in the training videos.

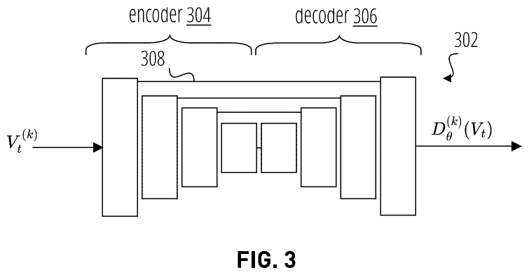

FIG. 3 depicts an embodiment of a denoising model based on a U-net network 302. The U-net network 302 may be configured to transform a noised input frame

$${V}_{t}^{( k )}$$

into a predicted denoised output frame

$${D}_{θ}^{( k )} ( {V}_{t} ) .$$

The U-net network 302 may be configured to be translation equivariant in accordance with the mechanisms described above.

The U-Net neural network derives its name from its shape, which resembles the letter “U”. It comprises an encoder 304 and a decoder 306. The encoder 304 comprises successive downsampling layers that reduce the dimensions of the input tensor, encoding its high-level features. Each convolutional layer may be followed for example by a rectified linear unit (ReLU) activation function to introduce non-linearity. As the encoder path progresses through the network, the resolution decreases while the number of feature channels increases. This effectively condenses the contextual information of the image into fewer channels.

Those of skill in the art will appreciate that a complete denoising model 102 may comprise additional features such as multi-layer attention, ResNet blocks, pooling, and normalizing layers.

The decoder 306, which follows after the encoder 304, reconstructs the original input tensor resolution from the condensed information. The decoder 306 comprises upsampling layers, for example transposed convolutions or bilinear upsampling, combined with skip connections 308 from the corresponding layers in the encoder path. The decoder 306 layers may for example be configured with ReLu (Rectified Linear Unit) or SiLu (Sigmoid Linear Unit) activations.

Skip connections enable the decoder 306 to leverage the high-resolution, low-level features learned by the encoder 304, preserving finer details during the upsampling process. To combine the information from the skip connections 308 and the upsampling layers, concatenation (not depicted) may be applied. This enables the decoder 306 to exploit both high-level and low-level features, promoting localization accuracy.

The decoder 306 path may terminate with a 1×1 convolutional layer followed by a suitable activation function, such as sigmoid or Softmax. The output assigns a probability/prediction to regions or values of the input, indicating its likelihood of belonging to a specific class or category (e.g., noise or not). Overall, the U-Net network 302 architecture's symmetrical structure with skip connections 308 enables it to effectively leverage both global contextual information and local details.

The upsampling layers of the decoder 306 may in one embodiment be implemented using a sinc interpolation kernel. The downsampling layers of the encoder 304 may be implemented with strided (stride >1) sampling and a low-pass filter front-end to omit high-frequency spectrum from the input to the strided sampling layer. Commonly utilized non-linear activations such as ReLU and Swish, and normalization layers such as layer norm may introduce high-frequency components that generate aliasing artifacts. These artifacts may be avoided by first upsampling the signal and then applying (e.g., via skip connections 308) the activations/norms in the upsampled domain before downsampling again.

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary architectures will now be described that may be configured to implement the mechanisms disclosed herein, for example as machine memories (e.g., memory 420, main memory 904) comprising machine-readable instructions that when executed by a computer system comprising one or more GPU and/or CPU configure the computer system to implement the disclosed mechanisms.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

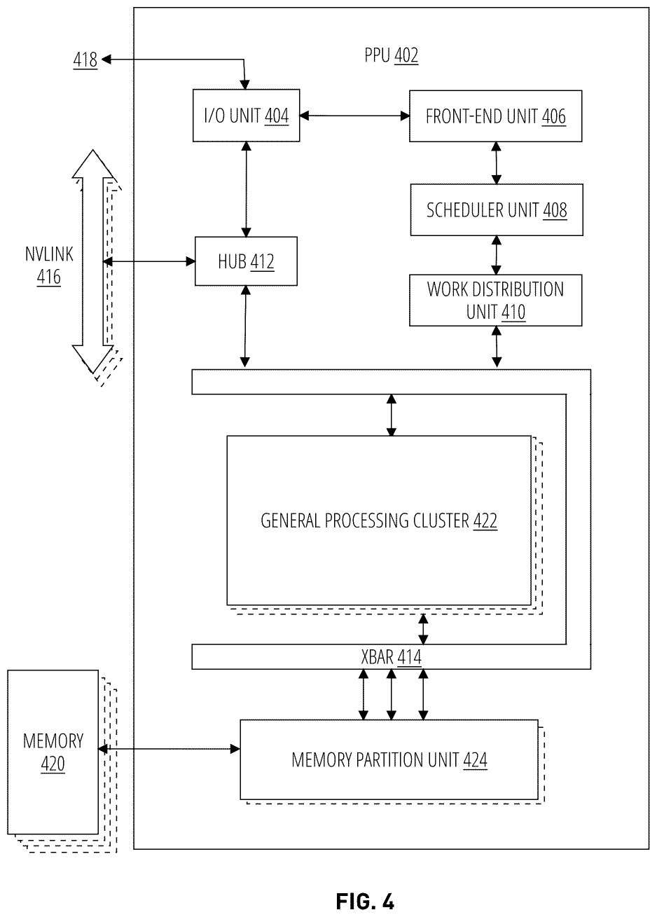

FIG. 4 depicts a parallel processing unit 402, in accordance with an embodiment. In an embodiment, the parallel processing unit 402 is a multi-threaded processor that is implemented on one or more integrated circuit devices. The parallel processing unit 402 is a latency hiding architecture designed to process many threads in parallel. A thread (e.g., a thread of execution) is an instantiation of a set of instructions configured to be executed by the parallel processing unit 402. In an embodiment, the parallel processing unit 402 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 402 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 402 modules may be configured to accelerate thousands of High Performance Computing (HPC), data center, and machine learning applications. The parallel processing unit 402 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the parallel processing unit 402 includes an I/O unit 404, a front-end unit 406, a scheduler unit 408, a work distribution unit 410, a hub 412, a crossbar 414, one or more general processing cluster 422 modules, and one or more memory partition unit 424 modules. The parallel processing unit 402 may be connected to a host processor or other parallel processing unit 402 modules via one or more high-speed NVLink 416 interconnects. The parallel processing unit 402 may be connected to a host processor or other peripheral devices via an interconnect 418. The parallel processing unit 402 may also be connected to a local memory comprising a number of memory 420 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 420 may comprise logic to configure the parallel processing unit 402 to carry out aspects of the techniques disclosed herein.

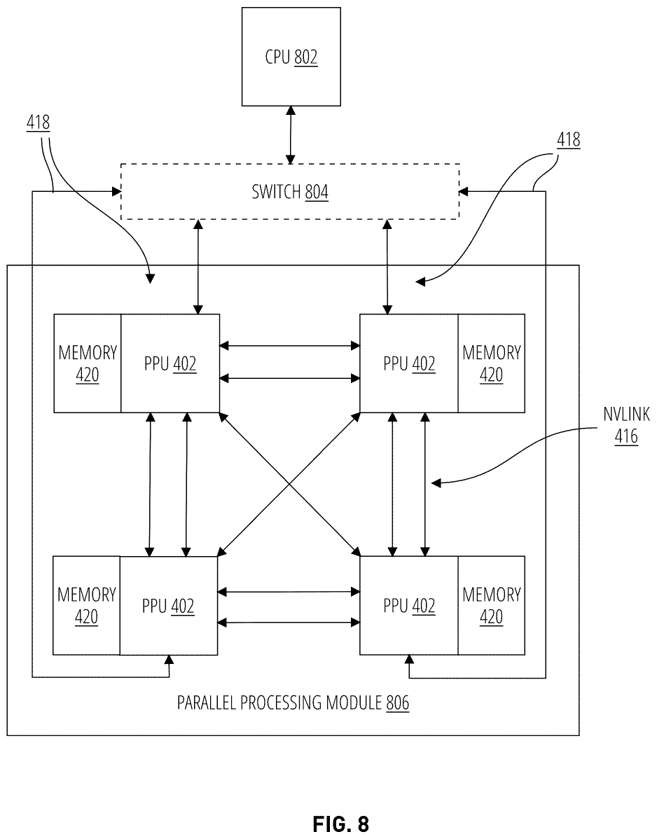

The NVLink 416 interconnect enables systems to scale and include one or more parallel processing unit 402 modules combined with one or more CPUs, supports cache coherence between the parallel processing unit 402 modules and CPUs, and CPU mastering. Data and/or commands may be transmitted by the NVLink 416 through the hub 412 to/from other units of the parallel processing unit 402 such as one or more copy engines, a video encoder, a video decoder, a power management unit, etc. (not explicitly shown). The NVLink 416 is described in more detail in conjunction with FIG. 8.

The I/O unit 404 is configured to transmit and receive communications (e.g., commands, data, etc.) from a host processor (not shown) over the interconnect 418. The I/O unit 404 may communicate with the host processor directly via the interconnect 418 or through one or more intermediate devices such as a memory bridge. In an embodiment, the I/O unit 404 may communicate with one or more other processors, such as one or more parallel processing unit 402 modules via the interconnect 418. In an embodiment, the I/O unit 404 implements a Peripheral Component Interconnect Express (PCIe) interface for communications over a PCIe bus and the interconnect 418 is a PCIe bus. In alternative embodiments, the I/O unit 404 may implement other types of well-known interfaces for communicating with external devices.

The I/O unit 404 decodes packets received via the interconnect 418. In an embodiment, the packets represent commands configured to cause the parallel processing unit 402 to perform various operations. The I/O unit 404 transmits the decoded commands to various other units of the parallel processing unit 402 as the commands may specify. For example, some commands may be transmitted to the front-end unit 406. Other commands may be transmitted to the hub 412 or other units of the parallel processing unit 402 such as one or more copy engines, a video encoder, a video decoder, a power management unit, etc. (not explicitly shown). In other words, the I/O unit 404 is configured to route communications between and among the various logical units of the parallel processing unit 402.

In an embodiment, a program executed by the host processor encodes a command stream in a buffer that provides workloads to the parallel processing unit 402 for processing. A workload may comprise several instructions and data to be processed by those instructions. The buffer is a region in a memory that is accessible (e.g., read/write) by both the host processor and the parallel processing unit 402. For example, the I/O unit 404 may be configured to access the buffer in a system memory connected to the interconnect 418 via memory requests transmitted over the interconnect 418. In an embodiment, the host processor writes the command stream to the buffer and then transmits a pointer to the start of the command stream to the parallel processing unit 402. The front-end unit 406 receives pointers to one or more command streams. The front-end unit 406 manages the one or more streams, reading commands from the streams and forwarding commands to the various units of the parallel processing unit 402.

The front-end unit 406 is coupled to a scheduler unit 408 that configures the various general processing cluster 422 modules to process tasks defined by the one or more streams. The scheduler unit 408 is configured to track state information related to the various tasks managed by the scheduler unit 408. The state may indicate which general processing cluster 422 a task is assigned to, whether the task is active or inactive, a priority level associated with the task, and so forth. The scheduler unit 408 manages the execution of a plurality of tasks on the one or more general processing cluster 422 modules.

The scheduler unit 408 is coupled to a work distribution unit 410 that is configured to dispatch tasks for execution on the general processing cluster 422 modules. The work distribution unit 410 may track a number of scheduled tasks received from the scheduler unit 408. In an embodiment, the work distribution unit 410 manages a pending task pool and an active task pool for each of the general processing cluster 422 modules. The pending task pool may comprise a number of slots (e.g., 32 slots) that contain tasks assigned to be processed by a particular general processing cluster 422. The active task pool may comprise a number of slots (e.g., 4 slots) for tasks that are actively being processed by the general processing cluster 422 modules. As a general processing cluster 422 finishes the execution of a task, that task is evicted from the active task pool for the general processing cluster 422 and one of the other tasks from the pending task pool is selected and scheduled for execution on the general processing cluster 422. If an active task has been idle on the general processing cluster 422, such as while waiting for a data dependency to be resolved, then the active task may be evicted from the general processing cluster 422 and returned to the pending task pool while another task in the pending task pool is selected and scheduled for execution on the general processing cluster 422.

The work distribution unit 410 communicates with the one or more general processing cluster 422 modules via crossbar 414. The crossbar 414 is an interconnect network that couples many of the units of the parallel processing unit 402 to other units of the parallel processing unit 402. For example, the crossbar 414 may be configured to couple the work distribution unit 410 to a particular general processing cluster 422. Although not shown explicitly, one or more other units of the parallel processing unit 402 may also be connected to the crossbar 414 via the hub 412.

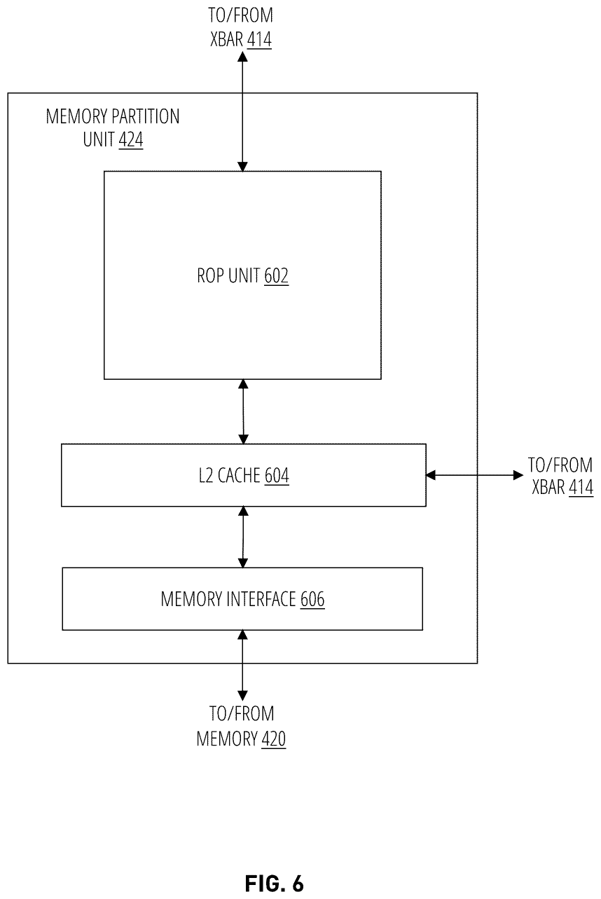

The tasks are managed by the scheduler unit 408 and dispatched to a general processing cluster 422 by the work distribution unit 410. The general processing cluster 422 is configured to process the task and generate results. The results may be consumed by other tasks within the general processing cluster 422, routed to a different general processing cluster 422 via the crossbar 414, or stored in the memory 420. The results can be written to the memory 420 via the memory partition unit 424 modules, which implement a memory interface for reading and writing data to/from the memory 420. The results can be transmitted to another parallel processing unit 402 or CPU via the NVLink 416. In an embodiment, the parallel processing unit 402 includes a number U of memory partition unit 424 modules that is equal to the number of separate and distinct memory 420 devices coupled to the parallel processing unit 402. A memory partition unit 424 will be described in more detail below in conjunction with FIG. 6.

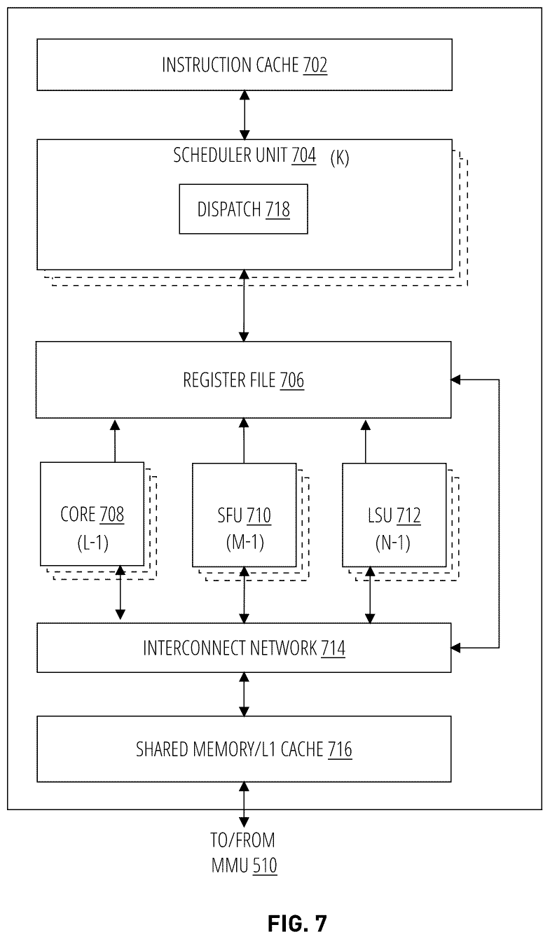

In an embodiment, a host processor executes a driver kernel that implements an application programming interface (API) that enables one or more applications executing on the host processor to schedule operations for execution on the parallel processing unit 402. In an embodiment, multiple compute applications are simultaneously executed by the parallel processing unit 402 and the parallel processing unit 402 provides isolation, quality of service (QoS), and independent address spaces for the multiple compute applications. An application may generate instructions (e.g., API calls) that cause the driver kernel to generate one or more tasks for execution by the parallel processing unit 402. The driver kernel outputs tasks to one or more streams being processed by the parallel processing unit 402. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 7.

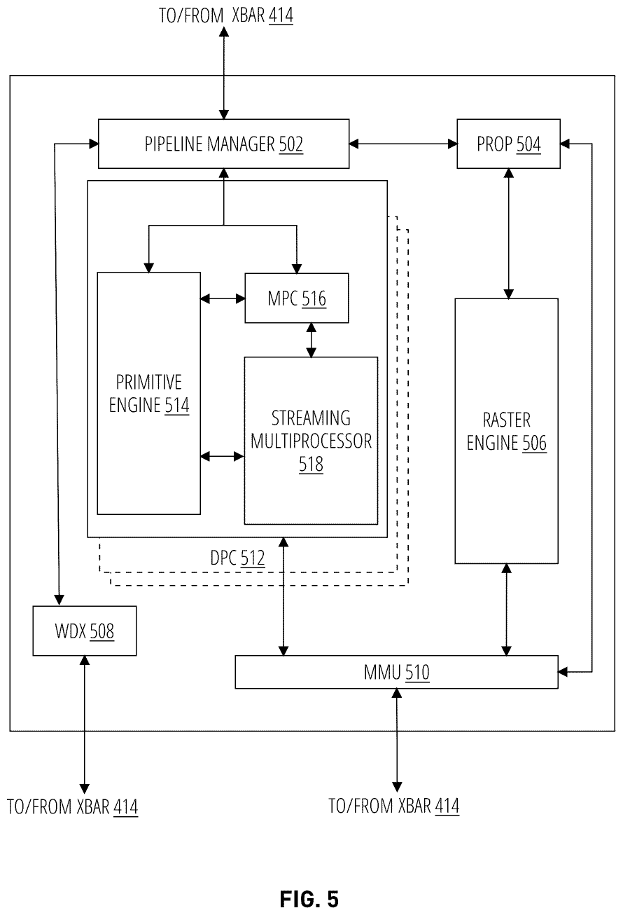

FIG. 5 depicts a general processing cluster 422 of the parallel processing unit 402 of FIG. 4, in accordance with an embodiment. As shown in FIG. 5, each general processing cluster 422 includes a number of hardware units for processing tasks. In an embodiment, each general processing cluster 422 includes a pipeline manager 502, a pre-raster operations unit 504, a raster engine 506, a work distribution crossbar 508, a memory management unit 510, and one or more data processing cluster 512. It will be appreciated that the general processing cluster 422 of FIG. 5 may include other hardware units in lieu of or in addition to the units shown in FIG. 5.

In an embodiment, the operation of the general processing cluster 422 is controlled by the pipeline manager 502. The pipeline manager 502 manages the configuration of the one or more data processing cluster 512 modules for processing tasks allocated to the general processing cluster 422. In an embodiment, the pipeline manager 502 may configure at least one of the one or more data processing cluster 512 modules to implement at least a portion of a graphics rendering pipeline. For example, a data processing cluster 512 may be configured to execute a vertex shader program on the programmable streaming multiprocessor 518. The pipeline manager 502 may also be configured to route packets received from the work distribution unit 410 to the appropriate logical units within the general processing cluster 422. For example, some packets may be routed to fixed function hardware units in the pre-raster operations unit 504 and/or raster engine 506 while other packets may be routed to the data processing cluster 512 modules for processing by the primitive engine 514 or the streaming multiprocessor 518. In an embodiment, the pipeline manager 502 may configure at least one of the one or more data processing cluster 512 modules to implement a neural network model and/or a computing pipeline.

The pre-raster operations unit 504 is configured to route data generated by the raster engine 506 and the data processing cluster 512 modules to a Raster Operations (ROP) unit, described in more detail in conjunction with FIG. 6. The pre-raster operations unit 504 may also be configured to perform optimizations for color blending, organize pixel data, perform address translations, and the like.

The raster engine 506 includes a number of fixed function hardware units configured to perform various raster operations. In an embodiment, the raster engine 506 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 506 comprises fragments to be processed, for example, by a fragment shader implemented within a data processing cluster 512.

Each data processing cluster 512 included in the general processing cluster 422 includes an M-pipe controller 516, a primitive engine 514, and one or more streaming multiprocessor 518 modules. The M-pipe controller 516 controls the operation of the data processing cluster 512, routing packets received from the pipeline manager 502 to the appropriate units in the data processing cluster 512. For example, packets associated with a vertex may be routed to the primitive engine 514, which is configured to fetch vertex attributes associated with the vertex from the memory 420. In contrast, packets associated with a shader program may be transmitted to the streaming multiprocessor 518.

The streaming multiprocessor 518 comprises a programmable streaming processor that is configured to process tasks represented by a number of threads. Each streaming multiprocessor 518 is multi-threaded and configured to execute a plurality of threads (e.g., 32 threads) from a particular group of threads concurrently. In an embodiment, the streaming multiprocessor 518 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 518 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 518 will be described in more detail below in conjunction with FIG. 7.

The memory management unit 510 provides an interface between the general processing cluster 422 and the memory partition unit 424. The memory management unit 510 may provide translation of virtual addresses into physical addresses, memory protection, and arbitration of memory requests. In an embodiment, the memory management unit 510 provides one or more translation lookaside buffers (TLBs) for performing translation of virtual addresses into physical addresses in the memory 420.

FIG. 6 depicts a memory partition unit 424 of the parallel processing unit 402 of FIG. 4, in accordance with an embodiment. As shown in FIG. 6, the memory partition unit 424 includes a raster operations unit 602, a level two cache 604, and a memory interface 606. The memory interface 606 is coupled to the memory 420. Memory interface 606 may implement 32, 64, 128, 1024-bit data buses, or the like, for high-speed data transfer. In an embodiment, the parallel processing unit 402 incorporates U memory interface 606 modules, one memory interface 606 per pair of memory partition unit 424 modules, where each pair of memory partition unit 424 modules is connected to a corresponding memory 420 device. For example, parallel processing unit 402 may be connected to up to Y memory 420 devices, such as high bandwidth memory stacks or graphics double-data-rate, version 5, synchronous dynamic random access memory, or other types of persistent storage.

In an embodiment, the memory interface 606 implements an HBM2 memory interface and Y equals half U. In an embodiment, the HBM2 memory stacks are located on the same physical package as the parallel processing unit 402, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 420 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 402 modules process very large datasets and/or run applications for extended periods.

In an embodiment, the parallel processing unit 402 implements a multi-level memory hierarchy. In an embodiment, the memory partition unit 424 supports a unified memory to provide a single unified virtual address space for CPU and parallel processing unit 402 memory, enabling data sharing between virtual memory systems. In an embodiment the frequency of accesses by a parallel processing unit 402 to memory located on other processors is traced to ensure that memory pages are moved to the physical memory of the parallel processing unit 402 that is accessing the pages more frequently. In an embodiment, the NVLink 416 supports address translation services allowing the parallel processing unit 402 to directly access a CPU's page tables and providing full access to CPU memory by the parallel processing unit 402.

In an embodiment, copy engines transfer data between multiple parallel processing unit 402 modules or between parallel processing unit 402 modules and CPUs. The copy engines can generate page faults for addresses that are not mapped into the page tables. The memory partition unit 424 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 420 or other system memory may be fetched by the memory partition unit 424 and stored in the level two cache 604, which is located on-chip and is shared between the various general processing cluster 422 modules. As shown, each memory partition unit 424 includes a portion of the level two cache 604 associated with a corresponding memory 420 device. Lower level caches may then be implemented in various units within the general processing cluster 422 modules. For example, each of the streaming multiprocessor 518 modules may implement an L1 cache. The L1 cache is private memory that is dedicated to a particular streaming multiprocessor 518. Data from the level two cache 604 may be fetched and stored in each of the L1 caches for processing in the functional units of the streaming multiprocessor 518 modules. The level two cache 604 is coupled to the memory interface 606 and the crossbar 414.

The raster operations unit 602 performs graphics raster operations related to pixel color, such as color compression, pixel blending, and the like. The raster operations unit 602 also implements depth testing in conjunction with the raster engine 506, receiving a depth for a sample location associated with a pixel fragment from the culling engine of the raster engine 506. The depth is tested against a corresponding depth in a depth buffer for a sample location associated with the fragment. If the fragment passes the depth test for the sample location, then the raster operations unit 602 updates the depth buffer and transmits a result of the depth test to the raster engine 506. It will be appreciated that the number of partition memory partition unit 424 modules may be different than the number of general processing cluster 422 modules and, therefore, each raster operations unit 602 may be coupled to each of the general processing cluster 422 modules. The raster operations unit 602 tracks packets received from the different general processing cluster 422 modules and determines which general processing cluster 1 that a result generated by the raster operations unit 602 is routed to through the crossbar 414. Although the raster operations unit 602 is included within the memory partition unit 424 in FIG. 6, in other embodiment, the raster operations unit 602 may be outside of the memory partition unit 424. For example, the raster operations unit 602 may reside in the general processing cluster 422 or another unit.

FIG. 7 illustrates the streaming multiprocessor 518 of FIG. 5, in accordance with an embodiment. As shown in FIG. 7, the streaming multiprocessor 518 includes an instruction cache 702, one or more scheduler unit 704 modules (e.g., such as scheduler unit 408), a register file 706, one or more processing core 708 modules, one or more special function unit 710 modules, one or more load/store unit 712 modules, an interconnect network 714, and a shared memory/L1 cache 716.

As described above, the work distribution unit 410 dispatches tasks for execution on the general processing cluster 422 modules of the parallel processing unit 402. The tasks are allocated to a particular data processing cluster 512 within a general processing cluster 422 and, if the task is associated with a shader program, the task may be allocated to a streaming multiprocessor 518. The scheduler unit 408 receives the tasks from the work distribution unit 410 and manages instruction scheduling for one or more thread blocks assigned to the streaming multiprocessor 518. The scheduler unit 704 schedules thread blocks for execution as warps of parallel threads, where each thread block is allocated at least one warp. In an embodiment, each warp executes 32 threads. The scheduler unit 704 may manage a plurality of different thread blocks, allocating the warps to the different thread blocks and then dispatching instructions from the plurality of different cooperative groups to the various functional units (e.g., core 708 modules, special function unit 710 modules, and load/store unit 712 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 718 unit is configured within the scheduler unit 704 to transmit instructions to one or more of the functional units. In one embodiment, the scheduler unit 704 includes two dispatch 718 units that enable two different instructions from the same warp to be dispatched during each clock cycle. In alternative embodiments, each scheduler unit 704 may include a single dispatch 718 unit or additional dispatch 718 units.

Each streaming multiprocessor 518 includes a register file 706 that provides a set of registers for the functional units of the streaming multiprocessor 518. In an embodiment, the register file 706 is divided between each of the functional units such that each functional unit is allocated a dedicated portion of the register file 706. In another embodiment, the register file 706 is divided between the different warps being executed by the streaming multiprocessor 518. The register file 706 provides temporary storage for operands connected to the data paths of the functional units.

Each streaming multiprocessor 518 comprises L processing core 708 modules. In an embodiment, the streaming multiprocessor 518 includes a large number (e.g., 128, etc.) of distinct processing core 708 modules. Each core 708 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 708 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 708 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 518 also comprises M special function unit 710 modules that perform special functions (e.g., attribute evaluation, reciprocal square root, and the like). In an embodiment, the special function unit 710 modules may include a tree traversal unit configured to traverse a hierarchical tree data structure. In an embodiment, the special function unit 710 modules may include texture unit configured to perform texture map filtering operations. In an embodiment, the texture units are configured to load texture maps (e.g., a 2D array of texels) from the memory 420 and sample the texture maps to produce sampled texture values for use in shader programs executed by the streaming multiprocessor 518. In an embodiment, the texture maps are stored in the shared memory/L1 cache 716. The texture units implement texture operations such as filtering operations using mip-maps (e.g., texture maps of varying levels of detail). In an embodiment, each streaming multiprocessor 518 includes two texture units.

Each streaming multiprocessor 518 also comprises N load/store unit 712 modules that implement load and store operations between the shared memory/L1 cache 716 and the register file 706. Each streaming multiprocessor 518 includes an interconnect network 714 that connects each of the functional units to the register file 706 and the load/store unit 712 to the register file 706 and shared memory/L1 cache 716. In an embodiment, the interconnect network 714 is a crossbar that can be configured to connect any of the functional units to any of the registers in the register file 706 and connect the load/store unit 712 modules to the register file 706 and memory locations in shared memory/L1 cache 716.

The shared memory/L1 cache 716 is an array of on-chip memory that allows for data storage and communication between the streaming multiprocessor 518 and the primitive engine 514 and between threads in the streaming multiprocessor 518. In an embodiment, the shared memory/L1 cache 716 comprises 128 KB of storage capacity and is in the path from the streaming multiprocessor 518 to the memory partition unit 424. The shared memory/L1 cache 716 can be used to cache reads and writes. One or more of the shared memory/L1 cache 716, level two cache 604, and memory 420 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 716 enables the shared memory/L1 cache 716 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 4, are bypassed, creating a much simpler programming model. In the general purpose parallel computation configuration, the work distribution unit 410 assigns and distributes blocks of threads directly to the data processing cluster 512 modules. The threads in a block execute the same program, using a unique thread ID in the calculation to ensure each thread generates unique results, using the streaming multiprocessor 518 to execute the program and perform calculations, shared memory/L1 cache 716 to communicate between threads, and the load/store unit 712 to read and write global memory through the shared memory/L1 cache 716 and the memory partition unit 424. When configured for general purpose parallel computation, the streaming multiprocessor 518 can also write commands that the scheduler unit 408 can use to launch new work on the data processing cluster 512 modules.

The parallel processing unit 402 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 402 is embodied on a single semiconductor substrate. In another embodiment, the parallel processing unit 402 is included in a system-on-a-chip (SoC) along with one or more other devices such as additional parallel processing unit 402 modules, the memory 420, a reduced instruction set computer (RISC) CPU, a memory management unit (MMU), a digital-to-analog converter (DAC), and the like.

In an embodiment, the parallel processing unit 402 may be included on a graphics card that includes one or more memory devices. The graphics card may be configured to interface with a PCIe slot on a motherboard of a desktop computer. In yet another embodiment, the parallel processing unit 402 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 8 is a conceptual diagram of a processing system implemented using the parallel processing unit 402 of FIG. 4, in accordance with an embodiment. The processing system includes a central processing unit 802, an switch 804, and multiple parallel processing unit 402 modules each and respective memory 420 modules. The switch 804 is depicted with dashed lines, indicating that it is optional in some embodiments.

The NVLink 416 provides high-speed communication links between each of the parallel processing unit 402 modules. Although a particular number of NVLink 416 and interconnect 418 connections are illustrated in FIG. 8, the number of connections to each parallel processing unit 402 and the central processing unit 802 may vary. The switch 804 interfaces between the interconnect 418 and the central processing unit 802. The parallel processing unit 402 modules, memory 420 modules, and NVLink 416 connections may be situated on a single semiconductor platform to form a parallel processing module 806. In an embodiment, the switch 804 supports two or more protocols to interface between various different connections and/or links.

In another embodiment (not shown), the NVLink 416 provides one or more high-speed communication links between each of the parallel processing unit modules (parallel processing unit 402, parallel processing unit 402, parallel processing unit 402, and parallel processing unit 402) and the central processing unit 802 and the switch 804 (when present) interfaces between the interconnect 418 and each of the parallel processing unit modules. The parallel processing unit modules, memory 420 modules, and interconnect 418 may be situated on a single semiconductor platform to form a parallel processing module 806. In yet another embodiment (not shown), the interconnect 418 provides one or more communication links between each of the parallel processing unit modules and the central processing unit 802 and the switch 804 interfaces between each of the parallel processing unit modules using the NVLink 416 to provide one or more high-speed communication links between the parallel processing unit modules. In another embodiment (not shown), the NVLink 416 provides one or more high-speed communication links between the parallel processing unit modules and the central processing unit 802 through the switch 804. In yet another embodiment (not shown), the interconnect 418 provides one or more communication links between each of the parallel processing unit modules directly. One or more of the NVLink 416 high-speed communication links may be implemented as a physical NVLink interconnect or either an on-chip or on-die interconnect using the same protocol as the NVLink 416.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 806 may be implemented as a circuit board substrate and each of the parallel processing unit modules and/or memory 420 modules may be packaged devices. In an embodiment, the central processing unit 802, switch 804, and the parallel processing module 806 are situated on a single semiconductor platform.

In an embodiment, each parallel processing unit module includes six NVLink 416 interfaces (as shown in FIG. 8, five NVLink 416 interfaces are included for each parallel processing unit module). The NVLink 416 may be operated exclusively for PPU-to-PPU communication as shown in FIG. 8, or some combination of PPU-to-PPU and PPU-to-CPU, when the central processing unit 802 also includes one or more NVLink 416 interfaces.

In an embodiment, the NVLink 416 allows direct load/store/atomic access from the central processing unit 802 to each parallel processing unit module's memory 420. In an embodiment, the NVLink 416 supports coherency operations, allowing data read from the memory 420 modules to be stored in the cache hierarchy of the central processing unit 802, reducing cache access latency for the central processing unit 802. In an embodiment, the NVLink 416 includes support for Address Translation Services (ATS), enabling the parallel processing unit module to directly access page tables within the central processing unit 802. One or more of the NVLink 416 may also be configured to operate in a low-power mode.

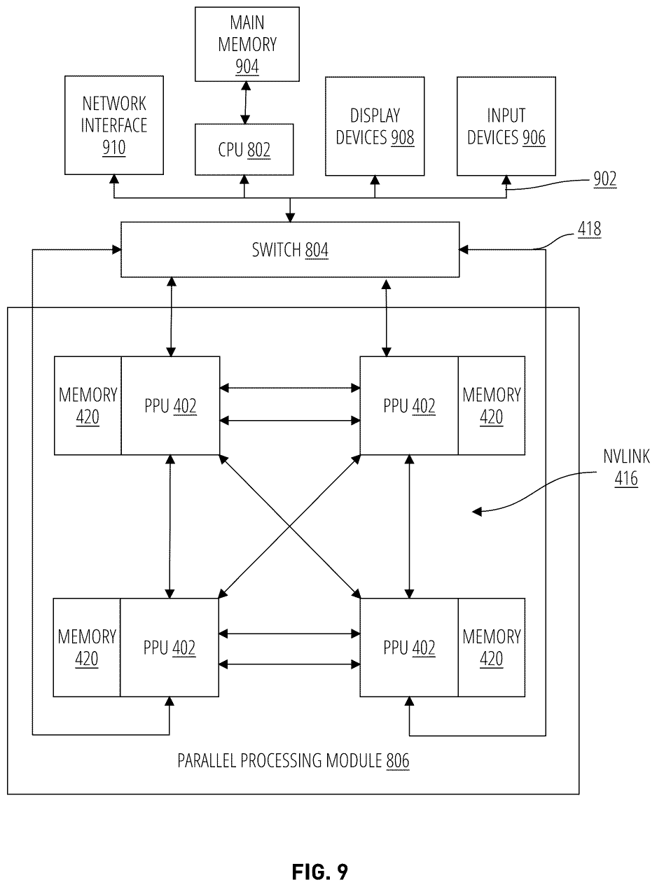

FIG. 9 depicts an exemplary processing system in which the various architecture and/or functionality of the various previous embodiments may be implemented. As shown, an exemplary processing system is provided including at least one central processing unit 802 that is connected to a communications bus 902. The communication communications bus 902 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 904. Control logic (software) and data are stored in the main memory 904 which may take the form of random access memory (RAM). For simplicity of illustration, the main memory 904 may be understood to comprise other forms of bulk memory, including non-volatile memory technologies.

The exemplary processing system also includes input devices 906, the parallel processing module 806, and display devices 908, e.g. a conventional CRT (cathode ray tube), LCD (liquid crystal display), LED (light emitting diode), plasma display or the like. User input may be received from the input devices 906, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 910 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 904 and/or the secondary storage. Such computer programs, when executed, enable the exemplary processing system to perform various functions. The main memory 904, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

Errors in optical flow estimation may lead to errors in warping transformation estimation. Successive frames in natural videos may not exhibit ideal 1:1 mapping because camera movement may cause some pixels that are visible in some frames to be hidden in others. Optical flow is conventionally estimated in the pixel space, whereas diffusion models operate in a latent space.

The latent embeddings of tracked pixels in optical flows may comprise high-frequency components in the temporal dimension that are not accounted for when adding constant warped noise across frames of the video. Diffusion models utilize a forward process that destroys frequency information, and the model learns to regenerate this information in the reverse process. To address these factors, independent noise may be added to each frame along with the temporally consistent warped noise during training. The total added noise may therefor be εₜₒₜ=βε_{warp}+\sqrt{1−β²}ε_{ind}.

The added independent noise expands the total noise manifold. The expanded noise manifold more thoroughly encompasses and destroys the latent encoding compared to the manifold of the warped noise alone. In one embodiment β=0.9 to inject a small amount of independent noise during training.

### LISTING OF DRAWING ELEMENTS

102 denoising model
104 loss function
106 Gaussian noise
302 U-net network
304 encoder
306 decoder
308 skip connection
402 parallel processing unit
404 I/O unit
406 front-end unit
408 scheduler unit
410 work distribution unit
412 hub
414 crossbar
416 NVLink
418 interconnect
420 memory
422 general processing cluster
424 memory partition unit
502 pipeline manager
504 pre-raster operations unit
506 raster engine
508 work distribution crossbar
510 memory management unit
512 data processing cluster
514 primitive engine
516 M-pipe controller
518 streaming multiprocessor
602 raster operations unit
604 level two cache
606 memory interface
702 instruction cache
704 scheduler unit
706 register file
708 core
710 special function unit
712 load/store unit
714 interconnect network
716 shared memory/L1 cache
718 dispatch
802 central processing unit
804 switch
806 parallel processing module
902 communications bus
904 main memory
906 input devices
908 display devices
910 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A process comprising:
generating a warped noise input by progressively applying a warping operator to noise added to video frames; and
training a video diffusion model using a video diffusion loss function modified to utilize the warped noise input.

2. The process of claim 1, wherein a warping operator for the warped noise input is consistent across frames of the video.

3. The process of claim 2, further comprising:
deriving the warping operator from a video.

4. The process of claim 2, further comprising:
deriving the warping operator from a three-dimensional (3D) mesh and camera trajectory.

5. The process of claim 1, further comprising:
applying a noise transport operation to the warped noise.

6. The process of claim 1, further comprising:
attaching a noise texture to a three-dimensional (3D) mesh.

7. The process of claim 6, further comprising:
generating renderings of the 3D mesh with the attached noise texture from multiple camera viewpoints.

8. The process of claim 7, further comprising:
providing the renderings as training inputs to the video diffusion model.

9. The process of claim 6, wherein the attached noise texture is Gaussian noise.

10. The process of claim 1, further comprising:
training the video diffusion model to be equivariant to spatial warping transformations of the warped noise input.

11. The process of claim 1, wherein the video diffusion loss function comprises a modified diffusion model L2 norm loss.

12. The process of claim 1, further comprising:
combining an independent noise input with the warped noise input.

13. A system for training a diffusion-based video denoising model to be equivariant to spatial transformations of video frames, the system comprising:
one or more processors;
a memory storing instructions that, when executed by the one or more processors, configure the system to:
generate noise inputs for frames of a training video sequence, the noise inputs comprising warped noise derived from a cumulative spatial warping transformation across the frames; and
tune parameters of the denoising model using a loss function configured to utilize the warped noise.

14. The system of claim 13, wherein the warped noise is generated by applying a warping operator derived from motion vectors of a driving video.

15. The system of claim 13, wherein the warping transformation applies spatial transformations to noise associated with temporally-preceding frames of the training video sequence to produce noise for temporally-subsequent frames of the training video sequence.

16. The system of claim 13, wherein the warped noise is generated using a noise transport operation configured to preserve a Gaussian distribution of noise within each of the frames.

17. The system of claim 13, wherein the warped noise is generated from Gaussian noise attached as a texture map to a three-dimensional mesh and rendered to image planes corresponding to camera viewpoints.

18. The system of claim 13, the denoising model comprises a three-dimensional denoising neural network.

19. A system comprising:
a video diffusion model;
logic configured to:
generate noise inputs for frames of a training video sequence, the noise inputs generated by applying a same noise warping operator cumulatively across a temporal ordering of the frames; and
tune parameters of the video diffusion model through a loss function configured to utilize the warped noise.

20. The system of claim 13, the logic further configured to derive the noise warping operator from motion vectors of a driving video.

21. The system of claim 13, the logic further configured to derive the noise warping operator from Gaussian noise attached as a texture map to a three-dimensional mesh and rendered to image planes corresponding to camera viewpoints.
